(19) United States
(12) Patent Application Publication
(10) Pub. No.: US 2026/0032249 A1
(43) Pub. Date: Jan. 29, 2026

(54) POSTERIOR SAMPLING COMPRESSION

(71) Applicant: Technion Research & Development Foundation Limited, Haifa (IL)

(72) Inventors: Michael Elad, Haifa (IL); Noam Elata, Haifa (IL); Tomer Michaeli, Haifa (IL)

(73) Assignee: Technion Research & Development Foundation Limited, Haifa (IL)

(21) Appl. No.: 19/262,130

(22) Filed: Jul. 8, 2025

Related U.S. Application Data
(60) Provisional application No. 63/668,729, filed on Jul. 8, 2024.

(51) Int. Cl. H04N 19/132; H04N 19/124; H04N 19/85

(52) U.S. Cl. CPC H04N 19/132; H04N 19/124; H04N 19/85

(57) ABSTRACT

A method for compressing an information unit, the method includes receiving, at a compression unit, the information unit; and preforming, by the compression unit, multiple iterations of a progressive compression process to (i) iteratively determine a function that reduces an uncertainty associated with the information unit, using a posterior sampler associated with the function, and (ii) apply the function on the information unit to provide quantized measurements of the information unit for use in reconstructing the information unit.

### CROSS REFERENCE

This application claims priority from U.S. provisional patent Ser. No. 63/668,729 filing date Jul. 8, 2024, which is incorporated herein by reference.

### BACKGROUND

There is a growing need to provide high quality compression and decompression method that minimize the content transmitted between the compressor and the decompressor.

### BRIEF DESCRIPTION

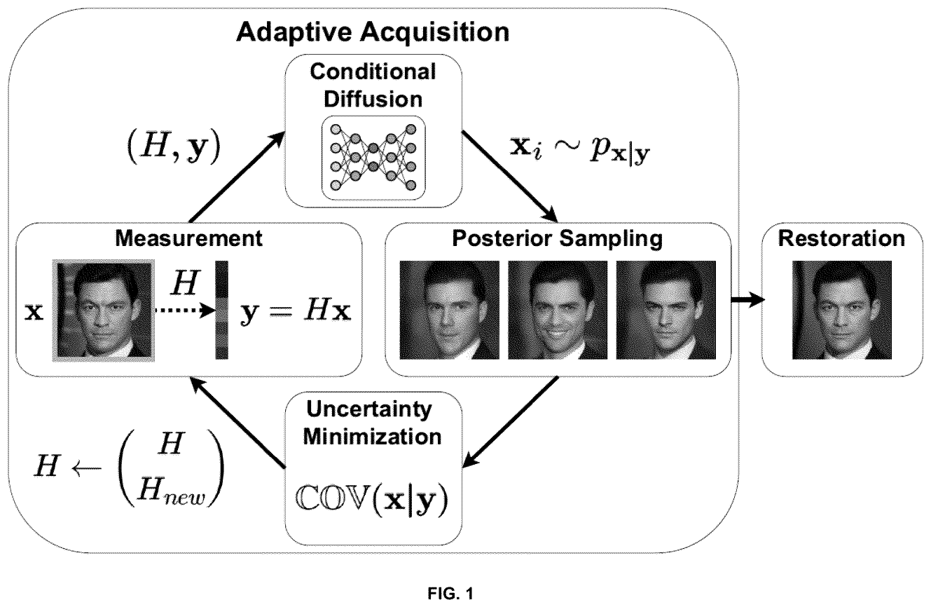

FIG. 1 illustrates an example of diagram of AdaSense.

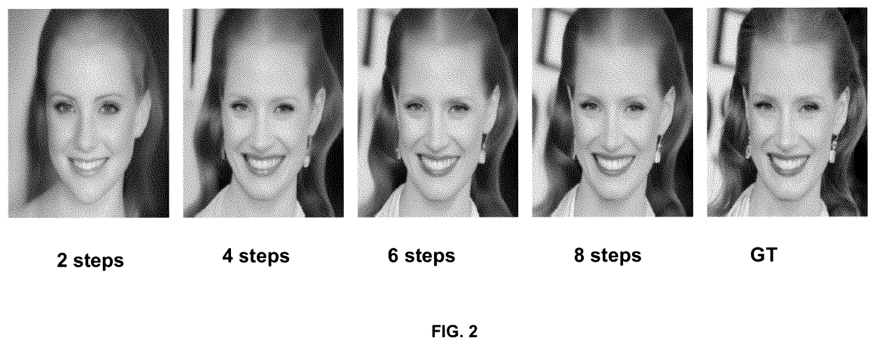

FIG. 2 illustrates an example of progressive restoration using AdaSense.

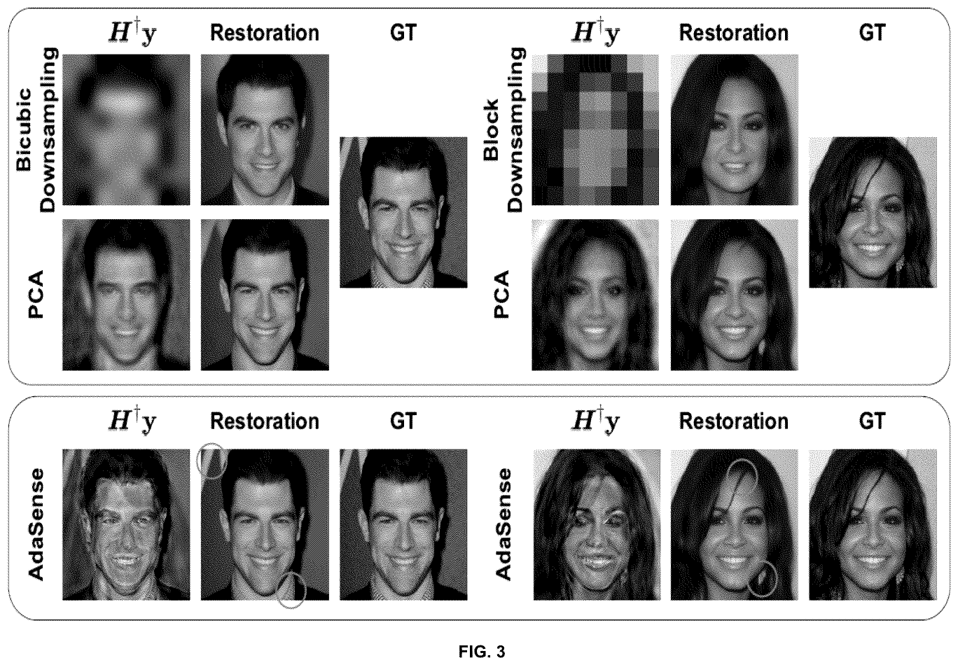

FIG. 3 illustrates an example of face image restoration using AdaSense.

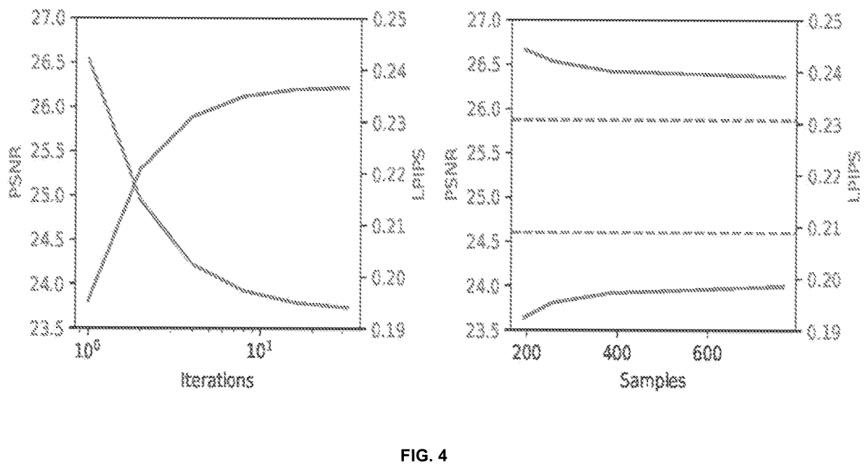

FIG. 4 illustrates an example of measurement results.

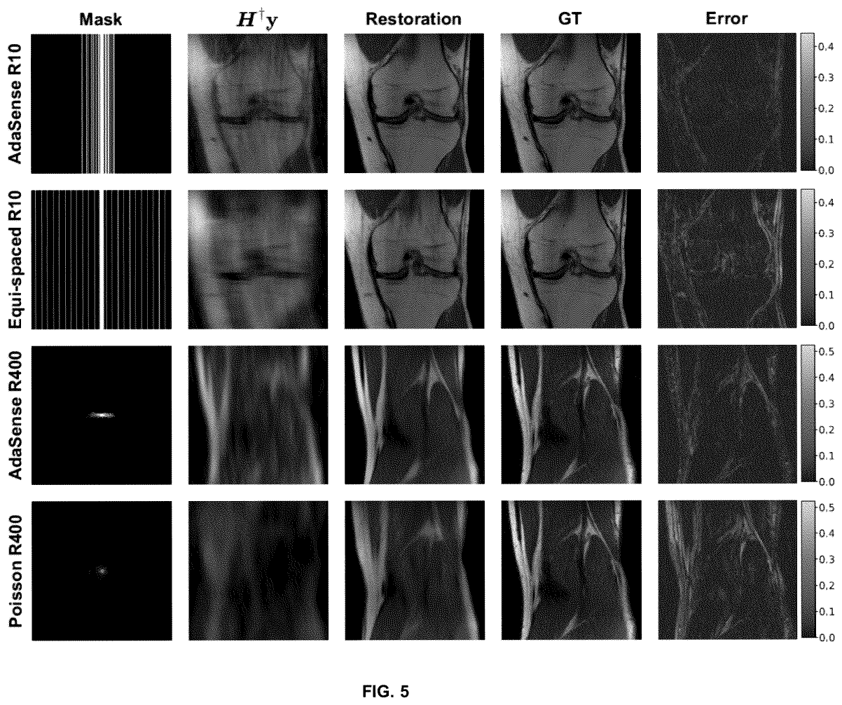

FIG. 5 illustrates an example of MRI active restoration using AdaSense.

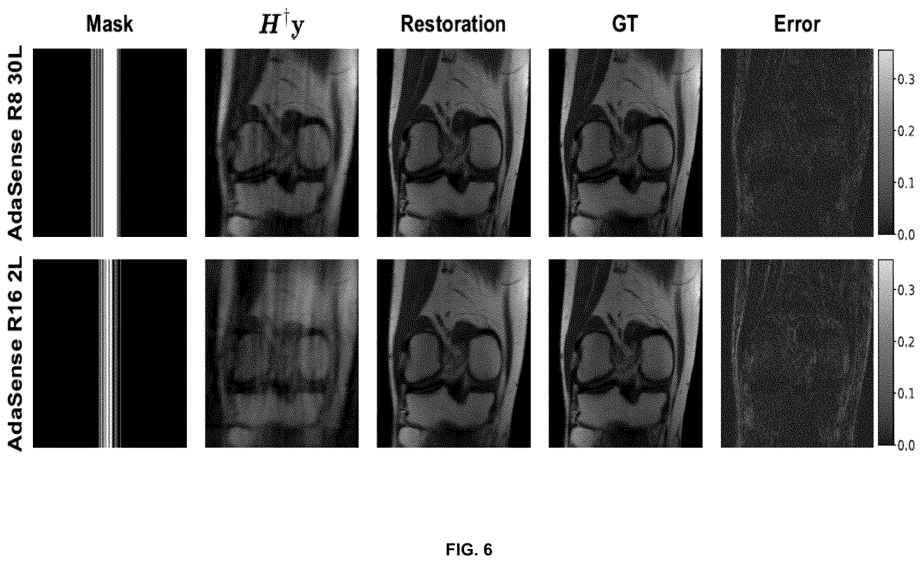

FIG. 6 illustrates an example of MRI active restoration using AdaSense.

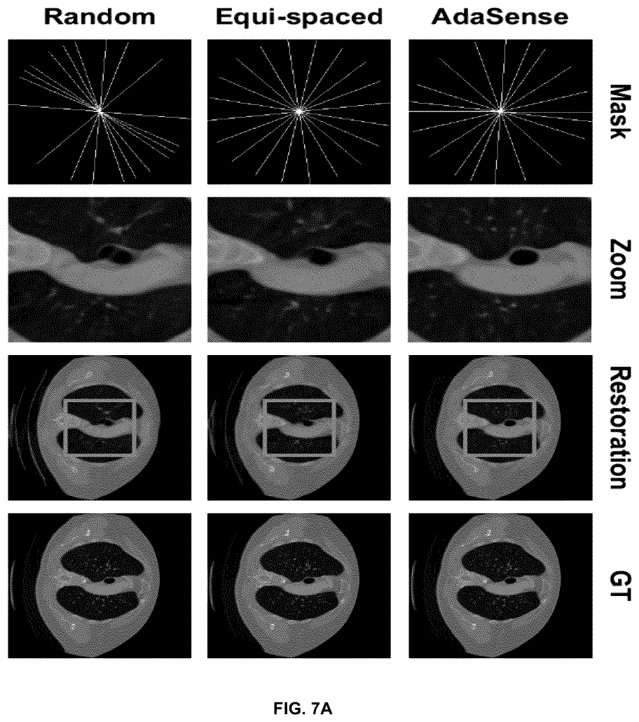

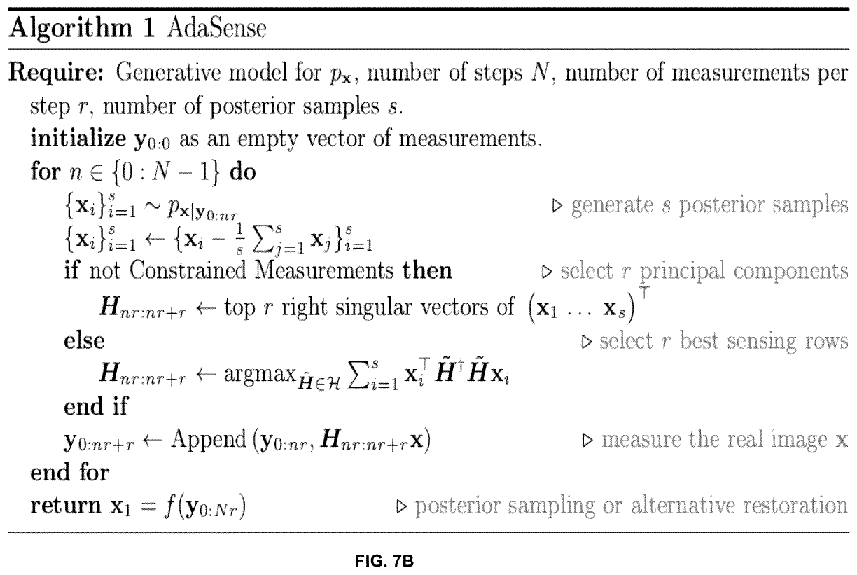

FIG. 7A illustrates an example of CT sparse view restoration using AdaSense.

FIG. 7B illustrates an example of algorithm 1.

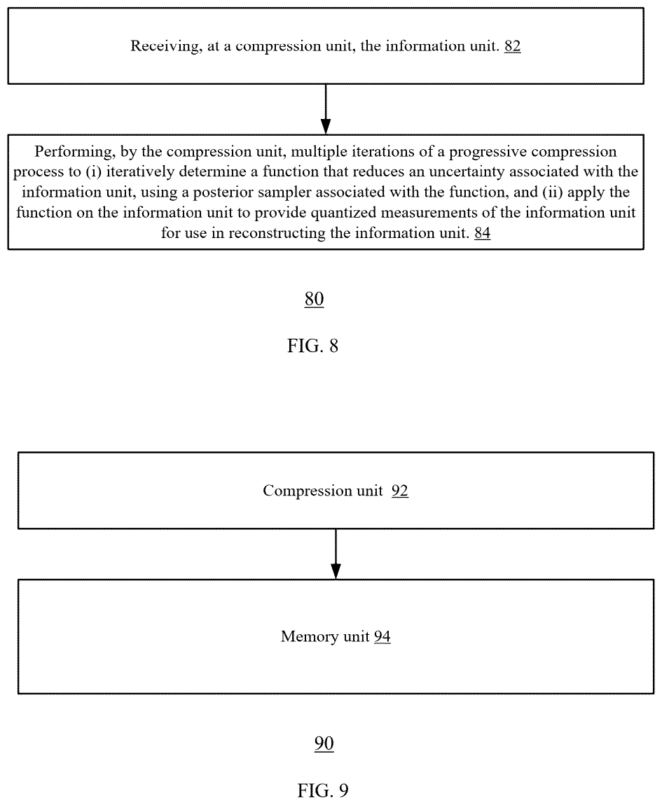

FIG. 8 illustrates an example of a method.

FIG. 9 illustrates an example of a computerized system.

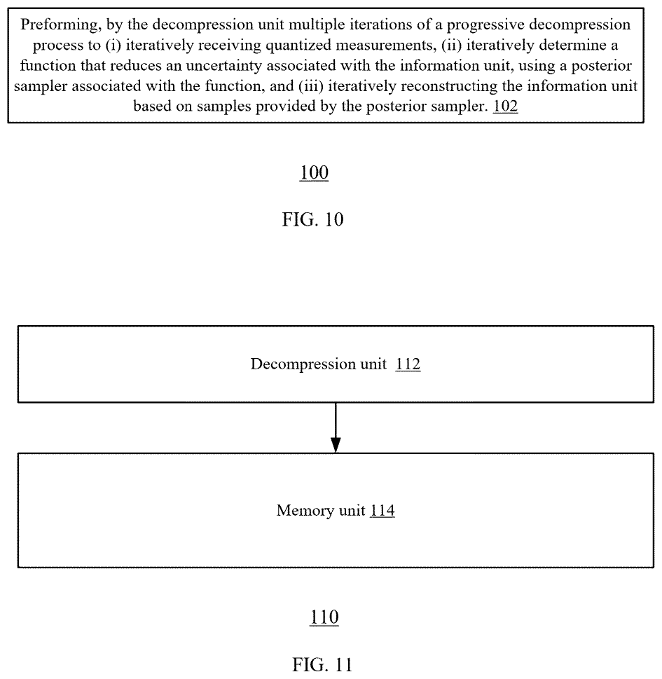

FIG. 10 illustrates an example of a method.

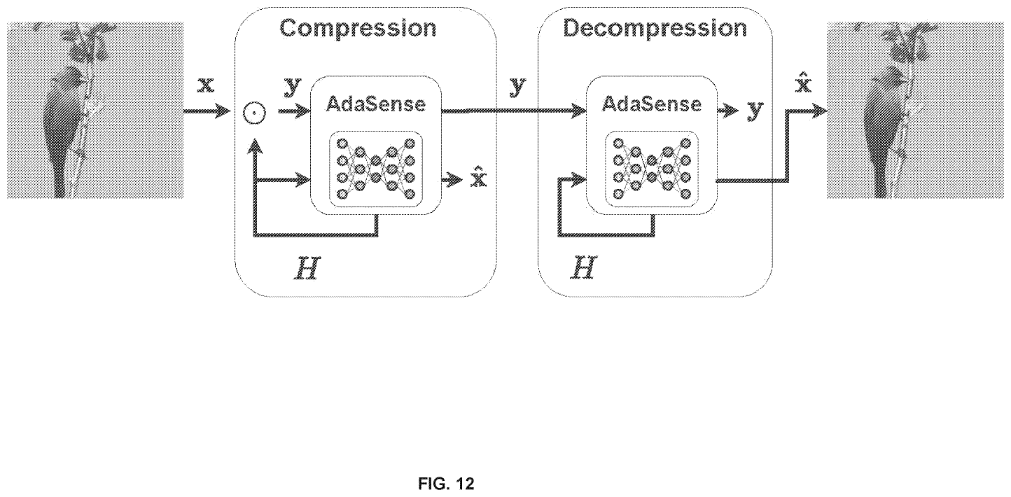

FIG. 11 illustrates an example of a computerized system.

FIG. 12 illustrates an example of a PSC diagram.

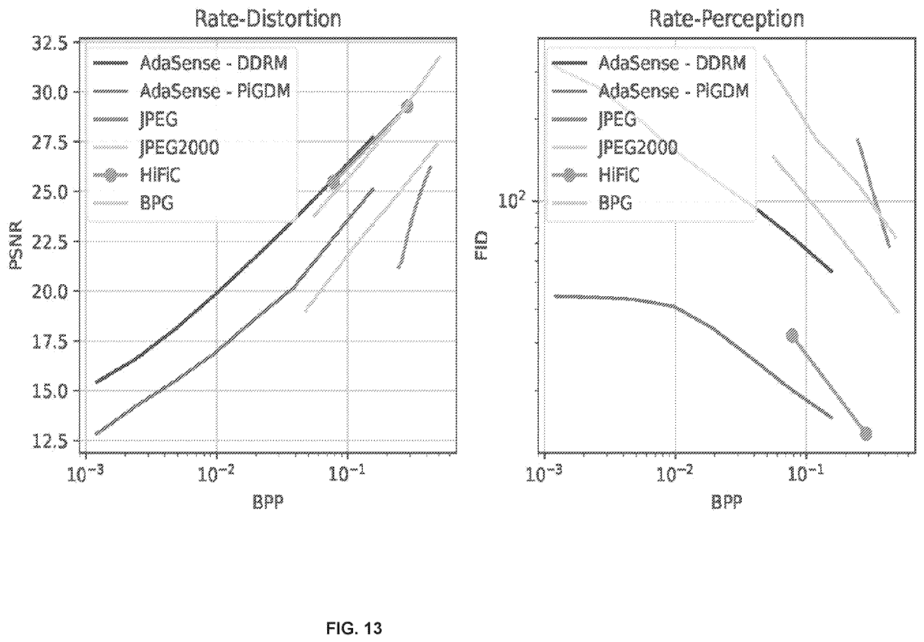

FIG. 13 illustrates an example of measurement results.

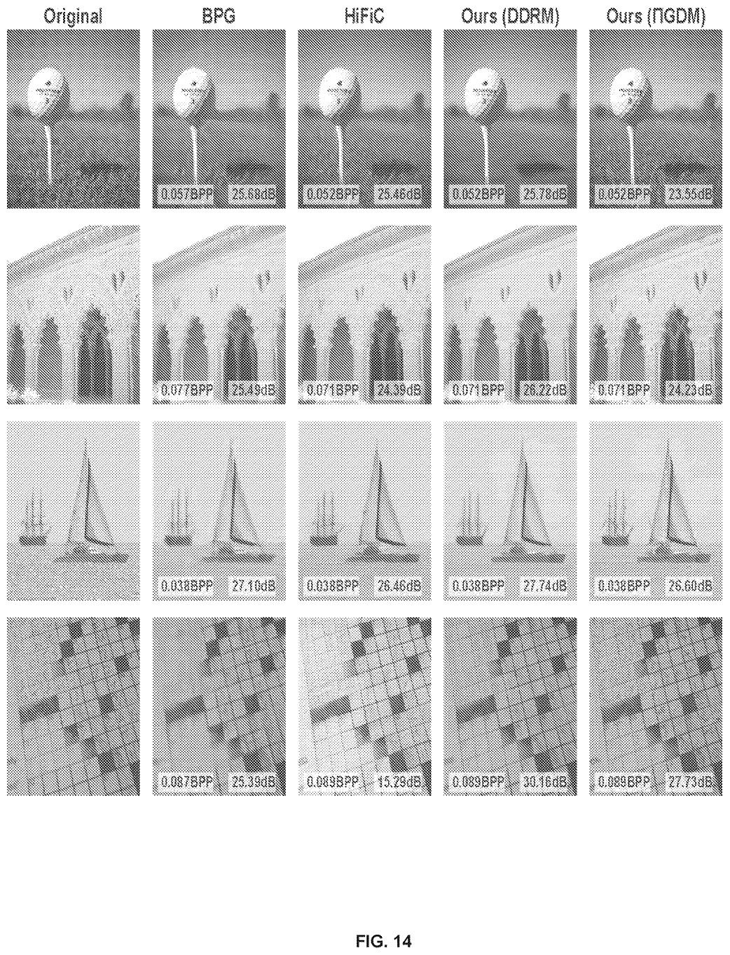

FIG. 14 illustrates an example of images and measurement results.

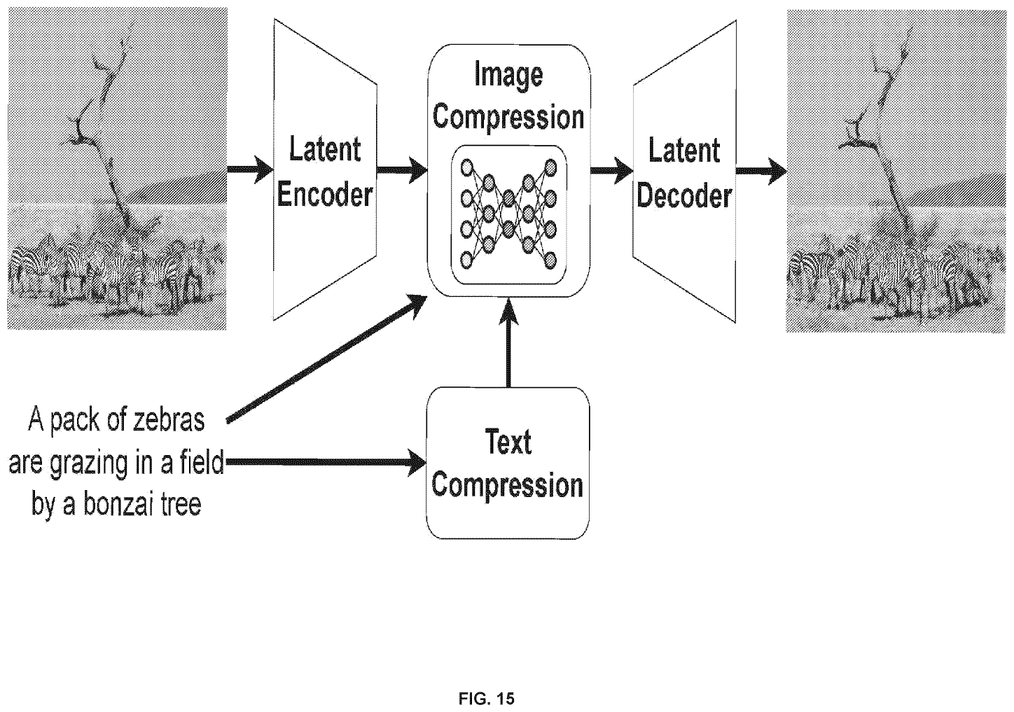

FIG. 15 illustrates an example of a latent-PSC.

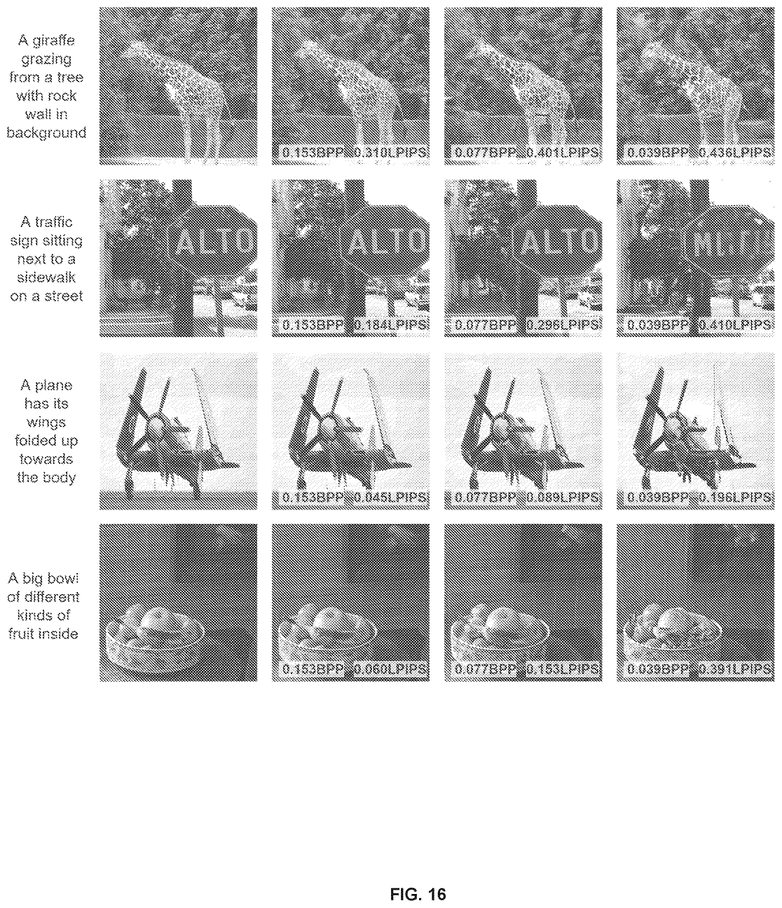

FIG. 16 illustrates an example of images and measurement results.

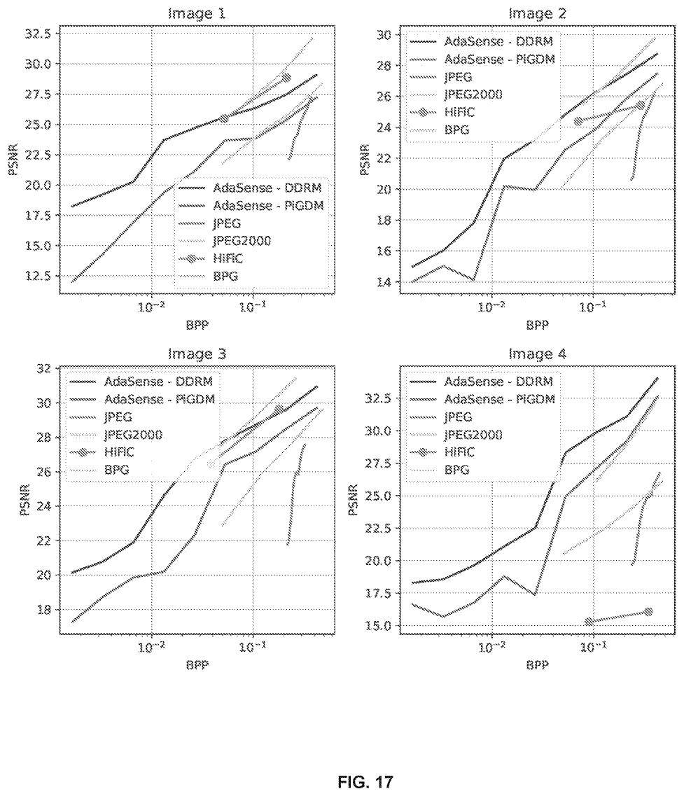

FIG. 17 illustrates an example of measurement results.

### DETAILD DESCRIPTION

The specification provides an example of posterior sampling that is deployed for achieving state-of-the-art sensing and compression. AdaSense is introduced and is a method for constructing a signal-adaptive sensing matrix for best compressed-sensing performance. AdaSense is being utilized by PSC-a posterior-sampler based compression paradigm.

### AdaSense

Compressed Sensing (CS) facilitates rapid image acquisition by selecting a small subset of measurements sufficient for high-fidelity reconstruction.

Adaptive CS seeks to further enhance this process by dynamically choosing future measurements based on information gleaned from data that is already acquired.

However, many existing frameworks are often tailored to specific tasks and require intricate training procedures.

AdaSense leverages zero-shot posterior sampling with pre-trained diffusion models.

By sequentially sampling from the posterior distribution, we can quantify the uncertainty of each possible future linear measurement throughout the acquisition process.

AdaSense eliminates the need for additional training and boasts seamless adaptation to diverse domains with minimal tuning requirements.

Our experiments demonstrate the effectiveness of AdaSense in reconstructing facial images from a small number of measurements.

Furthermore, we apply AdaSense for active acquisition of medical images in the domains of magnetic resonance imaging (MRI) and computed tomography (CT), highlighting its potential for tangible real-world acceleration.

Compressed sensing (CS) methods have shown promise in image acquisition and reconstruction by leveraging the statistical prior of real-world signals. This allows capturing significant information using fewer measurements, which is crucial when acquisition is time-consuming or costly. To further optimize this process, adaptive CS techniques use reconstructions based on existing measurements to dynamically prioritize subsequent ones. Both adaptive and non-adaptive CS have benefited from the recent surge in deep learning research.

Existing methods for measurement selection are typically either heuristic or involve training complex models on simulated subsampled data. The complexity escalates when these methods are adaptive, as they necessitate fine-tuning the algorithm to the specific modality and subsampling schemes applied.

Consequently, such approaches are often limited in their modality, and struggle to adapt to changes within their domain.

Driven by recent advancements in zero-shot diffusion-based methods for solving linear inverse problems, we propose AdaSense, an image reconstruction technique for active measurement acquisition. These methods leverage pre-trained diffusion models to capture the data distribution, modifying the sampling algorithm to function as posterior distribution samplers. Using candidate posterior samples, AdaSense is able to quantify the reconstruction uncertainty associated with each possible future measurement, guiding the selection of the optimal subsequent measurement through a sequential algorithm. By employing zero-shot diffusion-based methods, AdaSense eliminates the need for additional training or fine-tuning, making it applicable across varied domains and acquisition schemes. Moreover, AdaSense operates under the assumption that access to training data is restricted, which is common in the sensitive medical domain. We offer several key insights to ensure AdaSense is computationally efficient.

To validate the approach, AdaSense is applied in various settings, including general image reconstruction and active acquisition of medical images. For general reconstruction, we compare AdaSense to other common subsampling techniques on facial images and attempt to quantify the performance gain of adaptive restoration compared to non-adaptive alternatives. In the medical image domain, the inventors showcase AdaSense as an active acquisition tool for both k-space magnetic resonance imaging (MRI) subsampling and sparse-view computed tomography (CT). In such scenarios, measurement subsampling may expedite the lengthy acquisition process and reduce patient exposure to radiation.

### First Problem Formulation

We are interested in reconstructing a signal x in RD from d<D linear measurements of the form y=Hx(1), where H∈R^{d*D} is the sensing matrix and y∈R_{D} is the vector of measurements. the inventors assume that x is a random vector whose distribution pₓ is either known or has been learned by a generative model based on a large corpus of training samples.

Our goal is to determine the matrix H that allows the best possible recovery of x in the mean squared error (MSE) sense. Importantly, the inventors assume that they may select the measurements (the rows of H) in a sequential manner, taking advantage of information gained from previous measurements.

Let us first discuss the simplified non-adaptive setting, in which the entire matrix His determined a-priori without dependence on the measurements. In this setting, the optimization problem we would like to solve is argminE_{H,f}∈[∥f(Hx)−x∥²] (2) where f:R^{d} to R^{D} is a function that reconstructs x from the measurements Hx. In principle, the optimal H and f(.) may be determined by training an auto-encoder with a linear encoder H and a nonlinear decoder f(.). However, as will become clear below, adapting this strategy to the adaptive CS setting is computationally impractical.

A more scalable approach is to restrict the decoder function to be an affine transformation of the form f(y)=Uy+b, relying on the assumption that the optimal H for this case is also nearly optimal. In this setting, the optimization problem becomes is argminE_{U,b,H}E[∥UHx+b−x∥²]

This problem corresponds to principal component analysis (PCA). Therefore, the optimal sensing matrix H has the top d eigenvectors of Cov[x] as its rows, the optimal decoding matrix is U=H^{T}, and the optimal bias is b= (I−H^{T}H)\E[x].

Namely, PCA minimizes the uncertainty, defined as the MSE attained by the linear minimum-MSE (MMSE) predictor of x based on the measurements y. This is achieved by choosing the measurement matrix H accordingly to minimize this error.

We next address the adaptive case, where the rows of H are chosen sequentially, such that each row (or chunk of rows) is chosen based on the measurements acquired with the preceding rows. We take a greedy approach, where in each stage we choose the new rows so as to allow minimization of the reconstruction error at that stage, without taking into consideration their effect on the reconstruction error at future stages. In particular, we propose to use PCA to find the optimal rows in each stage.

We denote by H_{i,j} the sub-matrix of H corresponding to rows i to j (including row i and excluding row j) and denote by y_{i,j} the corresponding measurements, y_{i,j}=H_{i,j}x. We aim to construct the whole matrix H in N steps, selecting r new rows in each step. Therefore, at step n, we rely on the previous nr measurements y_{0:nr}.

Following the same PCA strategy discussed for the non-adaptive case, we propose choosing the sub-matrix H_{nr:nr+r} at stage n, as equation (4)

$$\begin{matrix}{H}_{nr : nr + r} = arg {min}_{V , U , b , \tilde{H}} E [ {\vert \vert ( VU ) ( \begin{matrix}{H}_{0 : nr} \\ \tilde{H}\end{matrix} ) x + b - x \vert \vert}^{2} \vert {y}_{0 : nr} ] = \\ = arg {min}_{V , U , b , \tilde{H}} E [ {\vert \vert {V}_{{y}_{0 : nr}} + U \tilde{H} x + b - x \vert \vert}^{2} \vert {y}_{0 : nr} ]\end{matrix}$$

Here, (VU) serves as the linear reconstruction matrix and we used the fact that H_{0:nr} x=y_{0:nr}.

Due to the conditioning on y_{0:nr}, the vector V_{y}_{_{0:nr}}+b can be viewed as a deterministic bias term (playing the role of bin in equation (3). Therefore, similarly to equation (3), the optimal \tilde{H} in this case corresponds to the top r eigenvectors Cov[x|y_{0:nr}].

Once H_{nr:nr+r} is determined, we can use it to obtain r new measurements, y_{nr:nr+r}=H_{nr:nr+r}x, and append them to our previous ones as y_{0:nr+r}=(y_{0:nr}^{T} y_{nr:nr+r}^{T}). We may repeat this process until we have chosen all N r rows of H. Finally, we may restore our final measurements with a nonlinear reconstruction function f(y).

The iterative approach described above requires knowing the posterior covariance matrix Cov[x|y_{0:nr}] in each stage, or at least its top eigenvectors.

To obtain an approximation of these principal components, we propose harnessing zero-shot posterior sampling methods that are based on a pre-trained diffusion model. These methods allow generating samples from the posterior distribution of x given y_{0:nr} for problems in which y_{0:nr} is a linear transformation of x, as in our setting. Given a set of s such posterior samples, we can apply PCA to determine the top eigenvectors of the (empirical) posterior covariance. Our sampling algorithm (AdaSense) is presented in FIG. 2, including the constrained measurement scenario which we describe in the constrained measurements section.

### Constrained Measurement

In certain real-world applications, the sensing matrix is constrained due to physical limitations. One notable example is MRI, in which the signal is measured in k-space, so that the rows of H are restricted to be rows of the Fourier transform matrix. Another important example is CT, in which the signal is measured in Radon space. In this setting, the rows of H are constrained to be rows of the Radon transform matrix. To adapt our method to such scenarios, we therefore need to choose the best option from a predefined set H of feasible sensing matrices. In other words, we need to solve equation (4) under the constraint H\tilde{ }∈H. The matrix achieving the optimum of this constrained optimization problem is the solution to equation (5):

[symbol]

Tr{Cov[x|y_{0:nr}]²\tilde{H}^{T}(\tilde{H}Cov[x|y_{0:nr}]\tilde{H}^{T})⁻¹}

Note that as opposed to the unconstrained case, if H is not the entire space R^{r×D}, then the solution to this optimization problem is not necessarily the top eigenvectors of Cov [x|y_{0:nr}].

Unfortunately, in many practical cases the number of rows r selected in each step is unavoidably large. For example, in MRI, we would often like to measure a whole column of the 2d Fourier transform of the image at a time. Similarly in CT, we would often like to measure a whole column of the sinogram at a time. In such scenarios, attempting to directly approximate the solution to Eq. (5) becomes prohibitively expensive. This is because for the r×r matrix \tilde{ } Cov [x|y_{0:nr}]\tilde{ }^{T} to be invertible, the rank of our approximation of the covariance Cov[x|y_{0:nr}] must be at least r. This requires generating s≥r posterior samples in each step, which is impractical with today's zero-shot posterior samplers for the typical values of r in e.g. MRI and CT. To overcome this computational difficulty, we propose a sub-optimal solution, which nonetheless works quite well in practice. Specifically, rather than optimizing over the reconstruction matrix U in Eq. (4), we set it to be H \tilde{ }^{†}, which is its optimal values in the unconstrained scenario. As we demonstrate in App. A.2, this simplifies the problem to equation (6) argmax

[symbol]

[x− [symbol] [x|y_{0:i}])^{T}\tilde{H}^{T}\tilde{H}((x− [symbol] [x|y_{0:i}])]

The solution to this problem can again be approximated using posterior samples, by replacing expectations by averages and exhaustively scanning all matrices in H. This search space becomes impractically large to scan if we attempt to select several frequency columns in MRI or several sinogram columns in CT at once. In such cases, we use a heuristic. Restoration

Once we have obtained the optimal sensing matrix H using the method outlined above, we seek a function f(⋅) to restore our final set of measurements y_{0:Nr}. The most straightforward approach would be to use the same zero-shot posterior sampler for the final restoration, generating a single or multiple reconstructions. Another alternative involves using the average of several posterior sampler outputs. This average approximates the posterior mean, which is the minimum MSE (MMSE) estimator. A third alternative is to take the restoration function f(⋅) to be a neural network that is specifically tailored to the modality. Section 4.3 experiments with classical and deep learning reconstruction approaches specifically designed for MRI for improved restoration.

### Acceleration of Posterior Sampling

AdaSense, as outlined in Algorithm 1 of FIG. 7B, may be used with any posterior sampler. However, to avoid training for specific degradations we propose using a zero shot diffusion restoration method. While the mechanics of different methods differ, many approaches solely rely on the computation of the Moore-Penrose pseudo-inverse H^{†} of the degradation matrix H. Also, several zero-shot diffusion restoration methods are consistent with the measurements y, i.e. for any generated x the equation y=Hx holds¹. Below, we describe how we can greatly increase the efficiency of our implementation using such approaches.

The computation of H^{†}, could generally be computed for any degradation H using a computationally expensive SVD. Because the degradation matrix H is chosen at runtime in AdaSense, the SVD computation could potentially lead to slower sampling. Nevertheless, we offer several insights that explain why this repeated computation of SVD can be disregarded. Because a consistent posterior sampler is used, the variance along previously selected sensing matrix is necessarily zero. Therefore, for general measurements and cases of constrained measurements where the measurements are inherently non-overlapping (such as MRI subsampling), our choices for the next measurement H\tilde{ } are necessarily orthogonal to all previous measurements. This leads to the useful property where the low-rank SVD of our matrices H_{0:nr} is (U,Σ, V^{T})=(I,I,H_{0:nr}), eliminating the need for additional computation. Further details on are provided in the supplementary material. In other cases, such as sparse-view CT reconstruction, limiting AdaSense to a small number of total measurements ensures that the matrix H_{0:nr} remains low-rank, making SVD computation inexpensive.

### Experiments

We begin by testing AdaSense on 256×256 face images taken from the CelebAHQ [32,40] validation dataset. The pre-trained model from SDEdit was used with DDRM for diffusion-based sampling. We evaluate AdaSense's capabilities to select the best possible measurements by comparing reconstructions made using AdaSense's proposed sensing matrix to reconstructions from different common degradations. All degraded measurements are of dimension 192 and have been restored using the same algorithm (DDRM). AdaSense employed N=8 consecutive iterations, selecting r=24 elements per iteration. FIG. 3 showcases a qualitative comparison of AdaSense with other restoration approaches, highlighting its superior ability to preserve fine details and subject identity compared to alternatives. Qualitative result in Table 1 reveal that AdaSense outperforms other non-adaptive methods across all metrics, including PSNR, SSIM, LPIPS, and DeepFace cosine similarity. Notably, AdaSense surpasses a non-adaptive PCA approach that selects the optimal sensing matrix following Eq. (3) using real training images. This achievement highlights the effectiveness of AdaSense, especially considering it relies solely on approximated generated samples. In addition, we show how using the mean of the posterior sampler lowers the distortion of the final reconstruction (measured inPSNR and SSIM) while sacrificing the perceptual quality (measured in LPIPS).

### Importance of Adaptivity

The hyperparameter N governs the number of iterations in the measurement acquisition process. Within a constant total number of measurements N·r, AdaSense is deemed ‘less adaptive’ when r is larger at the expense of N, and ‘more adaptive’ otherwise. For N32 1, a single iteration is used, essentially eliminating the adaptive component of the algorithm.

To validate the significance of adaptivity in the restoration process, we compare our method's performance using different numbers of iterations for measurement acquisition, while maintaining the total number of measurements N·r. This ensures a fair comparison focused solely on the effect of adaptivity. Also, the value of s remains consistently proportional tor at a ratio of +4/3, ensuring consistent computational demands (measured by the total number of generated samples) across experiments. We retain the posterior sampler from Sec. 4.1, and adjust the AdaSense hyperparameters N,r,s to change the adaptivity of our algorithm. The results, illustrated in FIG. 4 demonstrates that both PSNR and LPIPS improve as the number of iterations used for measurement acquisition increases. This trend underscores the positive impact of adaptivity on the system's robustness and effectiveness, highlighting its crucial role within our proposed method.

### Active MRI Subsampling

In this section, we demonstrate the usefulness of AdaSense in active MRI subsampling. We use a diffusion model for complex 640×368 single-coil knee MRI images which we train on the FastMRI dataset, following established data pre-processing and model architecture and training procedures. We apply AdaSense for image reconstruction using DDRM under various acceleration schemes. Table 2 compares AdaSense to non-adaptive subsampling masks, including general subsampling with acceleration factor of 200 and 400 and vertical subsampling with acceleration factor of 10. Images are restored using posterior sampling or with a classical wavelet approach. We measure PSNR and SSIM on the central 320×320 region of the reconstructed MR images. As shown, AdaSense outperforms all nonadaptive measurements. Visualizations of the reconstructions are provided in FIG. 5. Furthermore, Tab. 3 compares AdaSense against established MRI active acquisition methods. For a fair comparison, all approaches use the same final reconstruction model employed in the referenced works, termed ‘Reconstructor’. We include results for the non-adaptive baseline strategy ‘Low-toHigh’, and the theoretical upper-bound ‘Greedy Oracle’.

Specifically, the ‘Greedy Oracle’ upper-bound is computed by searching all possible future measurements during each acquisition step and selecting the ones minimizing the reconstruction error relative to the ground truth, which is unavailable in real settings. Frequency selection utilizes only the image intensity of the central 320×320 region, where model evaluation takes place (details in App. D). Visual examples are included in FIG. 6. AdaSense remains competitive with similar training-based methods, despite requiring no additional training beyond the pre-trained diffusion model and never encountering degraded data during the diffusion model's training. This underscores AdaSense's advantage in adapting to any subsampling scheme.

Sparse-View CT Reconstruction. AdaSense can also be used for sparse-view CT reconstruction, by selecting the best projection angles for restoration. For this experiment, we have trained a simple diffusion model for 256×256 CT images from on the DeepLesion dataset. We simulate restoration of parallel-beam projections and measure PSNR and SSIM only within the valid region of the simulated projections. Similar to previous experiments, we use DDRM as our posterior sampler. Applying AdaSense to various acceleration schemes on samples from the validation set yields promising results, as showcased in FIG. 7A through both qualitative and quantitative data for sparse-view acquisitions.

### Posterior Sampling-Based Compression (PSC)

FIG. 8 illustrates an example of method 80 for compressing an information unit.

Method 80 includes step 82 of receiving, at a compression unit, the information unit.

Step 82 is followed by step 84 of performing, by the compression unit, multiple iterations of a progressive compression process to (i) iteratively determine a function that reduces an uncertainty associated with the information unit, using a posterior sampler associated with the function, and (ii) apply the function on the information unit to provide quantized measurements of the information unit for use in reconstructing the information unit. According to an embodiment, the measurements are linear projections

According to an embodiment, the measurements are generated during the multiple iterations, by using an information unit specific sensing matrix that is iteratively generated during the multiple iterations. An example of method 80 is provided in FIG. 12 and the unit specific sensing matrix is denoted H in FIG. 12.

According to an embodiment, during an iteration of the progressive compression process one or more rows are added to the image-specific sensing matrix.

According to an embodiment, the one or more rows are one or more principal directions of uncertainty.

According to an embodiment, method 80 also includes multiplying the information unit by the one or more principal directions of uncertainty to provide one or more of the quantized measurements.

According to an embodiment, step 84 is followed by step 86 of reconstructing the information unit using the quantized measurements and a posterior sampler of a decompression unit.

According to an embodiment there is provided a non-transitory computer readable medium for compressing an information unit, the non-transitory computer readable medium stores instructions executable by a computer for executing method 80.

The stores instructions executable by the computer may be for receiving, at a compression unit, the information unit; and preforming, by the compression unit, multiple iterations of a progressive compression process to (i) iteratively determine a function that reduces an uncertainty associated with the information unit, using a posterior sampler associated with the function, and (ii) apply the function on the information unit to provide quantized measurements of the information unit for use in reconstructing the information unit.

The non-transitory computer readable medium according to claim 8, wherein the measurements are linear projections.

FIG. 9 illustrates an example of computerized system 90 for compressing an information unit, the computerized system includes a compression unit 92 configured to receive the information unit; and preform multiple iterations of a progressive compression process to (i) iteratively determine a function that reduces an uncertainty associated with the information unit, using a posterior sampler associated with the function, and (ii) apply the function on the information unit to provide quantized measurements of the information unit for use in reconstructing the information unit. The compression unit 92 includes one or more integrated circuits and has access to memory unit 94 that stores instructions and/or information and/or metadata required for execution of method 80.

FIG. 10 is an example of a method 100 for decompressing. An example of method 100 is provided in FIG. 12.

According to an embodiment, method 100 includes step 102 of preforming, by the decompression unit multiple iterations of a progressive decompression process to (i) iteratively receiving quantized measurements, (ii) iteratively determine a function that reduces an uncertainty associated with the information unit, using a posterior sampler associated with the function, and (iii) iteratively reconstructing the information unit based on samples provided by the posterior sampler.

According to an embodiment, the function is a non-linear function.

According to an embodiment, the function is a linear function.

According to an embodiment, the function is represented by an information unit specific sensing matrix that is iteratively generated during the multiple iterations.

According to an embodiment, during an iteration of the progressive decompression process one or more rows are added to the image-specific sensing matrix.

According to an embodiment, there is provided non-transitory computer readable medium for decompressing an information unit, the non-transitory computer readable medium stores instructions executable by a processor for executing method 100. For example—instructions for preforming, by a decompression unit multiple iterations of a progressive decompression process to (i) iteratively receiving quantized measurements, (ii) iteratively determine a function that reduces an uncertainty associated with the information unit, using a posterior sampler associated with the function, and (iii) iteratively reconstructing the information unit based on samples provided by the posterior sampler.

FIG. 11 illustrates an example of computerized system 110 for decompressing an information unit, the computerized system comprises a decompression unit 112 configured to preform multiple iterations of a progressive decompression process to (i) iteratively receiving quantized measurements, (ii) iteratively determine a function that reduces an uncertainty associated with the information unit, using a posterior sampler associated with the function, and (iii) iteratively reconstructing the information unit based on samples provided by the posterior sampler.

The decompression unit 112 includes one or more integrated circuits and has access to memory unit 114 that stores instructions and/or information and/or metadata required for execution of method 100.

Either one of the compression unit 92 or the decompression unit 112 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. In the embodiments described herein, the illustrated examples may be implemented as circuitry located on a single integrated circuit or within a same device. Alternatively, the examples may be implemented as any number of separate integrated circuits or separate devices interconnected with each other in a suitable manner.

Either one of memory unit 94 or memory unit 114 may be a random access (RAM) memory unit, read only (ROM) memory unit, electrically erasable ROM (EEPROM) memory unit, flash memory, memristor memory unit, or other memory unit, or any other medium which can be used to store the desired information, and which can be accessed by a computer.

Diffusion models have transformed the landscape of image generation and now show remarkable potential for image compression.

Most of the recent diffusion-based compression methods require training and are tailored for a specific bitrate.

The PSC is a zero-shot compression method that leverages a pre-trained diffusion model as its sole neural network component, thus enabling the use of diverse, publicly available models without additional training.

Our approach is inspired by transform coding methods, which encode the image in some pre-chosen transform domain.

However, PSC constructs a transform that is adaptive to the image. This is done by employing a zero-shot diffusion-based posterior sampler so as to progressively construct the rows of the transform matrix. Each new chunk of rows is chosen to reduce the uncertainty about the image given the quantized measurements collected thus far. Importantly, the same adaptive scheme can be replicated at the decoder, thus avoiding the need to encode the transform itself. We demonstrate that even with basic quantization and entropy coding, PSC's performance is comparable to established training-based methods in terms of rate, distortion, and perceptual quality. This is while providing greater flexibility, allowing to choose at inference time any desired rate or distortion.

A suggested PSC diagram illustrates (see FIG. 12) an encoder and decoder that both construct an image-specific transform H through an adaptive compressed sensing algorithm, progressively adding rows based on posterior sample covariance. The transmission of quantized measurements y ensures identical inputs at each progressive step, while a shared random seed guarantees deterministic outputs on both sides. Together, these factors enable the construction of identical transforms on both sides-eliminating the need to transmit the transform as side information.

Referring again to FIG. 12—both the compression and the decompression parts employ the AdaSense algorithm for building an image-specific sensing matrix H, to which rows are added progressively based on posterior sample covariance. While the encoder requires access to the real image x for computing the measurements y, both the encoder and the decoder use the quantized measurements for the AdaSense computations. This, along with a coordinated random seed, guarantee that both sides produce the same deterministic outputs, alleviating the need for transmitting the sensing matrix as side information.

During each step of the compression phase, the system dynamically estimates the posterior probability distribution p (x|y0:k,H0:k), which is conditioned on the previously extracted H0:k and the corresponding quantized partial measurements y0:k. This estimation utilizes samples generated by a posterior sampler. Importantly, the zero-shot methods illustrated in the specification can solve any inverse problem of the form y=Q(Hx), enabling the utilization of pre-trained diffusion models without training. In practice, we use posterior samplers designed for linear inverse problems (without quantization). This allows using efficient samplers and leads to sufficiently accurate results.

The selection of the next row of H, denoted as hk∈R1×D, is determined by identifying the eigenvector corresponding to the largest eigenvalue of the posterior covariance.

This method ensures the projection of x occurs along the most informative direction, maximizing the value of incremental information gathered. The resulting measurement, yk=Q(hkx), is then appended to the previous compressed representation y0:k to form y0:k+1. This process effectively reduces the uncertainty of candidate images within the posterior distribution p(x|y0:k,H0:k) in a nearly optimal manner. Interestingly, as a by-product of the algorithm, the obtained sensing matrix H has orthogonal rows, disentangling the measurements, as expected from a compression algorithm.

This approach might appear counterintuitive for a transform coding, as it raises questions about the decoder's ability to determine the appropriate transform for image recovery. The naive approach of directly communicating the transform would be impractical, as it would require more bits than a lossless transmission of the image itself (the transform can be any matrix in RdxD). However, we present an elegant solution that circumvents this challenge through our progressive compression structure, which eliminates the need to communicate the transform entirely.

More specifically, PSC maintains a synchronized and identical state between encoder and decoder throughout its operation. The system relies on an agreed-upon seed, ensuring all random sampling operations produce deterministic and reproducible outputs. PSC initiates both encoder and decoder algorithms from the same empty matrix H0:0 and empty vector of previous quantized projections y0:0. Assuming that the previous steps were completed successfully—i.e. the accumulated matrix H0:k and quantized measurements y0:k are identical in both the encoder and decoder, we proceed to construct the next row of H0:k. During this computation, all posterior samples are identical in both encoder and decoder, ensuring the synchronization of the newly computed row hk. The encoder then evaluates and quantizes the new measurements yk=Q(hkx), incorporating them into the compressed representation transmitted to the decoder. Using the compressed representation, the decoder can utilize all measurements y0:k+1 directly in subsequent steps without requiring access to the input image.

This ensures that the inputs to the next iteration, H0:k+1 and y0:k+1, remain synchronized.

This novel approach to synchronized transform reconstruction is illustrated in FIG. 3. The complete procedures for compression and decompression with PSC, including the optimization of selecting r rows from matrix H for improved efficiency, are detailed in Algorithm 2 and Algorithm 3 respectively, and in US provisional patent U.S. provisional patent Ser. No. 63/668,729 which is incorporated herein by reference.

Algorithm 2

Require: Image x, number of steps N, number of measurements per step r.
initialize y 0:0 ,H 0:0 as an empty vector or matrix
for n ∈ {0 : N − 1} do
Hnr:nr+r ← SelectNewRows(H0:nr,y0:nr,r)
y0:nr+r ← Append[y0:nr,Q(Hnr:nr+rx)]
H0:nr+r ← Append[H0:nr,Hnr:nr+r]
Return Entropy Encode(y 0:Nr )

Algorithm 3

```
Require: compressed representation y, number of steps N,
number of measurements per step r.
  initialize y 0:Nr ← Entropy Decode(y)
  initialize H 0:0 as an empty matrix
  for n ∈ {0 : N − 1} do
  Hnr:nr+r ← SelectNewRows(H0:nr,y0:nr,r)
    H0:nr+r ← Append[H0:nr,Hnr:nr+r]
  return x\hat{ }
```

### Implementation Choices

FIG. 4 illustrates Qualitative examples for compression with PSC, compared to other compression algorithms. BPP and PSNR are reported per example. Our method can be used for both low-distortion or high perceptual quality using the same compressed representation.

We use DDRM as a zero-shot posterior sampler for the selection of H, due to its relatively low computational complexity. Due to the repeated sampling from different posteriors, PSC retains a high computational complexity, requiring approximately 10,000 NFEs for both compression and decompression. Nevertheless, we expect advances in diffusion models and posterior sampling to significantly expedite future versions. In our implementation we focus on an unsophisticated quantization approach, reducing the precision of y from float32 to float8.

We employ Range Encoding implemented using as an entropy coding on the quantized measurements. The quantization, the posterior sampler and the entropy coding could all be improved, posing promising directions for future work. Finally, after reproducing H on the decoder side, PSC may use a different final posterior sampler during decompression, in an attempt to further boost perceptual quality for the very same measurements y.

### Experiments

We begin with an evaluation of PSC on 256×256 color images from the ImageNet dataset, using the unconditional diffusion models from as an image prior. We compare distortion (PSNR), and bits-per-pixel (BPP) averaged on a subset of validation images, using one image from each of the 1000 classes. We apply PSC to progressively decode at higher rates.

A key advantage of PSC is its ability to prioritize perceptual quality during decompression by changing the final reconstruction algorithm. However, this flexibility comes with a caveat:using a high-quality reconstruction algorithm will inevitably lead to higher distortion. Despite this, using PSC, the same compressed representation can be decoded using either a low-distortion or high perceptual quality approach with minimal additional computational cost. Specifically, we find that IIGDM produces images with highest photorealism, while DDRM leads to the lowest distortion. We present both restoration solutions as PSC-Perception and PSC-Distortion accordingly.

FIG. 5 illustrates a rate-Distortion (left) and rate-perception (right) curves for ImageNet256 compression. Distortion is measured as average PSNR of images for the same desired rate or specified compression quality, while Perception (photorealism) is measured by FID.

FIG. 13 presents the rate-distortion and rate-perception curves of PSC compared to several established methods:classic compression techniques like JPEG, JPEG2000, and BPG. FIG. 13 includes Rate-Distortion (left) and Rate-Perception (right) curves for ImageNet256 compression. Distortion is measured as average PSNR of images for the same desired rate or specified compression quality, while Perception (image quality) is measured by FID.

We also compare neural compression methods and its diffusion-based derivative IPIC, as well as HiFiC, a prominent GAN-based neural compression method. Distortion is measured by averaging the PSNR across different algorithms for a given compression rate. Image quality is quantified using FID, estimated on 50 random 128×128 crops from each image, and compared to the same set of baselines. The graphs demonstrate that PSC achieves comparable performance, particularly at low BPP regimes, when considering both distortion and image quality.

FIG. 14 illustrates qualitative examples for compression with PSC, compared to other compression algorithms with similar BPP, BPP and PSNR each. Our method can be used for both low-distortion with DDRM or high perceptual quality with IIGDM using the same compressed representation. Notably, PSC achieves exceptional image quality despite the fact that it does not require any compression-specific training.

### Latent PSC

FIG. 15 illustrates an example of a Latent-PCS. Latent Text-to-Image diffusion models such as Stable Diffusion can be used for effective image compression with PSC. The latent representation is compressed using linear measurements. The textual prompt is used for conditioning the diffusion model in both the compression and decompression, and thus this text is also transmitted.

Latent Text-to-Image diffusion models have gained popularity due to their ease-of-use and low computational requirements. These models employ a VAE to conduct the diffusion process in a lower dimensional latent space. In this work we also explore the integration of PSC with Stable Diffusion, a publicly available latent Text-to-Image diffusion model. This variant, named latent-PSC, operates in the latent space of the diffusion model.

Both compression and decompression occur within this latent space, leveraging the model's VAE decoder to reconstruct the image from the decompressed latent representation. Additionally, we condition all posterior sampling steps on a textual description, which must be given along with the original image or inferred using an image captioning module. The text prompt must be added to the compressed representation to avoid side-information.

Due to the use of the VAE decoder, we expect a significant drop in PSNR. Thus, we develop latent-PSC as an extension of PSC-Perception, maintaining high perceptual quality at low bit-rates. We find that the posterior sampler outlined in Nested Diffusion (Elata et al., 2024a) works best in this setting. We use images from the CLIC and DIV2K to compare Latent-PSC to PerCo, a work which also utilizes latent diffusion for low-rate image compression. Using the same base diffusion model, image captioning model, and text compression as PerCo, we demonstrated that we are comparable in terms of both distortion (PSNR) and photorealism KID on all bit-rates despite not adding any training.

We also compare MS-ILLM, another compression method that focuses on high perceptual quality, as well as BPG, as a classical baseline. While the results of MS-ILLM do not suffer from the VAE-induced drop in PSNR, they do not reach the image quality of PerCo or Latent-PSC, especially at very low rates.

FIG. 16 illustrates qualitative examples of Latent-PSC with Stable Diffusion. For each image and corresponding text, several results for different bit-rates are shown. BPP and LPIPS are reported per each.

FIG. 17 illustrates rate-Distortion curves for specific images from ImageNet256. The images from FIG. 14 are used, numbered from top to bottom. Distortion is measured by PSNR of images.

While the current implementation of PSC used simplified quantization strategy for measurements presents another constraint. Implementation of more sophisticated quantization methods could yield significant improvements in compression rates. Furthermore, while some examples of PSC use linear measurements, imposed by both existing posterior sampler capabilities and the complexity of non-linear measurement optimization, the PCS may be enhanced through the exploration of non-linear measurements and corresponding inverse problem solvers.

In any case, PSC represents a significant advancement in zero-shot diffusion-based image compression through several distinct advantages. The method progressively acquires informative measurements to create compressed representations, with decompression faithfully reconstructing the original image by replicating the compression algorithm's steps. Its implementation simplicity, independence from training data, and cross-domain flexibility underscore its potential impact. Future developments promise to further advance this approach to both image compression and compression in general.

### Effect of Measurement Rank

We repeat the ImageNet experiment with different values of the hyperparameter r, which determines how adaptive our algorithm would be. We modify the number of samples generated at each iteration s accordingly to account for the rank required by the empirical covariance matrix. Based on the original implementation of AdaSense, we expect performance to improve the lower the value of r is.

Any reference to “may be” should also refer to “may not be”.

In the following detailed description, numerous specific details are set forth in order to provide a thorough understanding of the one or more embodiments of the disclosure. However, it will be understood by those skilled in the art that the present one or more embodiments of the disclosure may be practiced without these specific details. In other instances, well-known methods, procedures, and components have not been described in detail so as not to obscure the present one or more embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present one or more embodiments of the disclosure and in order not to obfuscate or distract from the teachings of the present one or more embodiments of the disclosure.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for compressing an information unit, the method comprising:
receiving, at a compression unit, the information unit; and
preforming, by the compression unit, multiple iterations of a progressive compression process to (i) iteratively determine a function that reduces an uncertainty associated with the information unit, using a posterior sampler associated with the function, and (ii) apply the function on the information unit to provide quantized measurements of the information unit for use in reconstructing the information unit.

2. The method according to claim 1, wherein the measurements are linear projections

3. The method according to claim 2, wherein the measurements are generated during the multiple iterations, by using an information unit specific sensing matrix that is iteratively generated during the multiple iterations.

4. The method according to claim 3, wherein during an iteration of the progressive compression process one or more rows are added to the image-specific sensing matrix.

5. The method according to claim 4, wherein the one or more rows are one or more principal directions of uncertainty.

6. The method according to claim 5, further comprising multiplying the information unit by the one or more principal directions of uncertainty to provide one or more quantized. linear projections of the image.

7. The method according to claim 1, further comprising, reconstructing the information unit using the quantized measurements and a posterior sampler of a decompression unit.

8. A non-transitory computer readable medium for compressing an information unit, the non-transitory computer readable medium stores instructions executable by a computer for: receiving, at a compression unit, the information unit; and preforming, by the compression unit, multiple iterations of a progressive compression process to (i) iteratively determine a function that reduces an uncertainty associated with the information unit, using a posterior sampler associated with the function, and (ii) apply the function on the information unit to provide quantized measurements of the information unit for use in reconstructing the information unit.

9. The non-transitory computer readable medium according to claim 8, wherein the measurements are linear projections.

10. The non-transitory computer readable medium according to claim 9, wherein the measurements are generated during the multiple iterations, by using an information unit specific sensing matrix that is iteratively generated during the multiple iterations.

11. The non-transitory computer readable medium according to claim 10, wherein during an iteration of the progressive compression process one or more rows are added to the image specific sensing matrix.

12. The non-transitory computer readable medium according to claim 11, wherein the one or more rows are one or more principal directions of uncertainty.

13. The non-transitory computer readable medium according to claim. 12, that further stores instructions for multiplying the information unit by the one or more principal

14. directions of uncertainty to provide one or more quantized linear projections of the image.

15. The non-transitory computer readable medium according to claim 8, that further stores instructions for reconstructing the information unit, using the quantized measurements and a posterior sampler of a decompression unit

16. A computerized system for compressing an information unit, the computerized system comprises:
a compression unit configured to receive the information unit; and preform multiple iterations of a progressive compression process to (i) iteratively determine a function that reduces an uncertainty associated with the information unit, using a posterior sampler associated with the function, and (ii) apply the function on the information unit to provide quantized measurements of the information unit for use in reconstructing the information unit.

17. The computerized system according to claim 8, wherein the measurements are linear projections.

18. The computerized system according to claim 9, wherein the measurements are generated during the multiple iterations, by using an information unit specific sensing matrix that is iteratively generated during the multiple iterations.

19. The computerized system according to claim 10, wherein during an iteration of the progressive compression process one or more rows are added to the image-specific sensing matrix.

20. The computerized system according to claim 12, wherein the one or more rows are one or more principal directions of uncertainty.

21. The computerized system according to claim 12, wherein the computerized system is further configured to multiply the information unit by the one or more principal directions of uncertainty to provide one or more quantized linear projections of the image.

22. The computerized system according to claim 8, that is further configured to reconstruct the information unit, using the quantized measurements and a posterior sampler of a decompression unit.

23. A method for decompressing an information unit the method comprising: preforming, by the decompression unit multiple iterations of a progressive decompression process to (i) iteratively receiving quantized measurements, (ii) iteratively determine a function that reduces an uncertainty associated with the information unit, using a posterior sampler associated with the function, and (iii) iteratively reconstructing the information unit based on samples provided by the posterior sampler.

24. The method according to claim 23, wherein the function is a non-linear function.

25. The method according to claim 23, wherein the function is a linear function.

26. The method according to claim 25, where the function is represented by an information unit specific sensing matrix that is iteratively generated during the multiple iterations.

27. The method according to claim 25, wherein during an iteration of the progressive decompression process one or more rows are added to the image-specific sensing matrix.

28. A non-transitory computer readable medium for decompressing an information unit, the non-transitory computer readable medium stores instructions executable by a processor for: preforming, by a decompression unit multiple iterations of a progressive decompression process to (i) iteratively receiving quantized measurements, (ii) iteratively determine a function that reduces an uncertainty associated with the information unit, using a posterior sampler associated with the function, and (iii) iteratively reconstructing the information unit based on samples provided by the posterior sampler.

29. The non-transitory computer readable medium according to claim 28, wherein the function is a non-linear function.

30. The non-transitory computer readable medium according to claim 28, wherein the function is a linear function.

31. The non-transitory computer readable medium according to claim 30, where the function is represented by an information unit specific sensing matrix that is iteratively generated during the multiple iterations.

32. The non-transitory computer readable medium according to claim 30, wherein during an iteration of the progressive decompression process one or more rows are added to the image-specific sensing matrix.

33. A computerized system for decompressing an information unit, the computerized system comprises a decompression unit configured to preform multiple iterations of a progressive decompression process to (i) iteratively receiving quantized measurements, (ii) iteratively determine a function that reduces an uncertainty associated with the information unit, using a posterior sampler associated with the function, and (iii) iteratively reconstructing the information unit based on samples provided by the posterior sampler.

34. The computerized system according to claim 33, wherein the function is a non-linear function.

35. The computerized system according to claim 33, wherein the function is a linear function.

36. The computerized system according to claim 35, where the function is represented by an information unit specific sensing matrix that is iteratively generated during the multiple iterations.

37. The computerized system according to claim 35, wherein during an iteration of the progressive decompression process one or more rows are added to the image-specific sensing matrix.
